(19) United States
(12) Patent Application Publication
(10) Pub. No.: US 2008/0224881 A1
(43) Pub. Date: Sep. 18, 2008

(54) PROTECTIVE COVER FOR A SENSOR

(76) Inventor: William Eaton, Brooklyn Park, MN (US)

Correspondence Address: MOORE & HANSEN, PLLP, 225 SOUTH SIXTH ST, MINNEAPOLIS, MN, 55402, US

(21) Appl. No.: 11/686,613

(22) Filed: Mar. 15, 2007

(51) Int. Cl. B23K 9/32

(52) U.S. Cl. 340/686.6; 340/693.5

(57) ABSTRACT

A protective cover for a sensing surface of a control sensor/proximity detector. The protective cover comprises a material having a preferred shore-A durometer hardness in the range of 60-90, a preferred tensile strength of 1320 psi (92.82 kilogram-force per square centimeter (kgf/cm2)) or greater, a preferred dielectric strength of around 300 volts/mil, and a preferred thermal conductivity of 0.3 to 0.5×10^{31 3} cal/sec², and a temperature stability of about −55 to +200 degrees Celsius. The protective cover may be adhesively secured to the proximity detector so that the sensing surface is effectively covered. The protective cover may be in the form of a sheet or may be in the form of a cap. Preferably, the protective cover comprises silicone material.

### BACKGROUND OF THE INVENTION

This invention relates generally to control sensors used in harsh operating conditions. More particularly, the present invention relates to a control sensor having an exterior surface that is provided with a protective cover that is resistant to high temperatures, weld flash, pitting, abrasion, acidic and caustic solutions, solvents, and the like.

Robotics and automation have been used in manufacturing for many years. A typical use for robotics and automation is in the automotive manufacturing industry, and particularly in operations such as car body assembly. In such operations, welding is the preferred method of joining car body parts together because it produces consistent, predictable results and the assembled car bodies are not only stronger and better able to resist vibrations, they are less likely to develop squeaks and rattles as they age. Car body fabrication generally involves moving a chassis or platform along an assembly line past a series of welding stations that join car body components such as door pillars, firewalls and floor pans together at predetermined weld locations on the chassis. Since the car body components are not all the same size, thickness and shape, it will be appreciated that different types of welds may be required. For instance, a door pillar may require one type of weld, a firewall may require another type of weld, and a floor pan may require yet another type of weld. And, since welding units are somewhat specialized, each welding station is often equipped with a plurality of different welding set-ups, for each particular type of weld that may be required. For example, a welding station may be equipped with stationary or mobile welding units that are used to join pieces of metal together. Or the welding station may be configured to provide different types of welds, such those produced by gas-metal arc welding (GMAW, also known as TIG or MIG welding), shielded metal arc welding (SMAW) and resistance spot welding.

It will be appreciated that it is not uncommon to fabricate different models or makes of vehicles at a single plant. That is, a particular car may be available as a coupe, a sedan, or a convertible. Or, a plant may be used to fabricate different makes of cars within a family of cars. In situations like this, welding requirements will vary between vehicle models and makes, and welding stations may be provided with extra welding units.

In such aforementioned automated or robotic welding units, welding operations are often partially controlled by sensors that detect the presence or absence of a work piece at a predetermined location, or which monitor and control robotic units as they traverse along predetermined paths. Such sensors are available in a wide variety of shapes and sizes and are usually referred to generically as proximity detectors.

Because of the harsh work environment inherent to welding stations, such sensors are usually provided with protective housings. Usually, at least one wall of the protective housing is composed of a non-metallic material such as glass reinforced thermoplastics or thermoset plastics against which the working end of the sensor is positioned and through which the sensor may operate. Such housings are also typically provided with brackets and fittings that allow the housing and sensor to be operatively connected to supports and other electrical components, respectively. In use, these protected sensors are usually positioned near the welding electrodes or rods so that they are better able to determine when a work piece and/or welding electrode or rod is in the correct position for welding. As one might expect, the closer a sensor is positioned to a welding electrode or rod, the more apt it is to be exposed to high temperatures, spattering, and weld flash.

However, in some instances, it is not possible or desirable to provide housing for the sensor. In such situations, the sensor is usually attached directly to a bracket or suitable support, and positioned so as to be able to operate as intended. These sensors also suffer from the same infirmities as the protectively housed sensors. That is, they are also subject to damage from high temperatures, spatter, weld flash, harsh environments and the like.

Additionally, sensors may be subject to accidental impacts from a variety of sources, inadvertent contact with corrosive chemicals, or temperature extremes, all of which may shorten the operational life of the sensors. For example, a sensor may be impacted and scratched by machinery that has become broken, bent or misaligned. A sensor might become inoperable due to contact with highly reactive materials used during fabrication, or corrosive chemicals used during periodic cleaning. In addition, the sensor might be exposed to ambient temperatures in excess of its designed operational range.

Of the aforementioned operational conditions, excessive heat, spattering, and weld flash are of the greatest concern because they cannot be easily ameliorated or eliminated. Excessive heat occurs during normal operation, particularly when the welding operations that involve gas-metal arc welding (GMAW). Heat that radiates from the arc and the weld pool formed by the arc can be quite high. For example, the arc, though relatively small, can range from about 3,000 to 20,000 degrees Celsius. And, steels have melting points in excess of 1,100 degrees Celsius. In addition, GMAW can often produce spattering, which is usually generated by droplets of weld material that impact the workpiece, but which do not form part of the weld.

Weld flash, which is similar to spatter, occurs during the welding operation and comprises small bullet-like projectiles of molten weld material that are randomly ejected from the weld site by minute impurities in the weld material as they are consumed by the heat generated by the welding electrodes or rods. These hot projectiles can vary in size from 5 to over 200 mg, have speeds of over 11 meters per second, and have kinetic energies of over 2.3×10⁻³ joules. Most of the projectiles are ejected radially from the weld site in a weld flash zone that is determined largely by the configuration of the parts being welded and the operational characteristics of the welding unit itself.

Unfortunately, for optimum operation, the sensor(s) usually are required to be positioned within the spatter and weld flash zones. While the odds of a sensor being impacted by spatter and/or weld flash are fairly low compared to the total area of the weld zones, one has to remember that robotic welders will perform a particular weld or welds hundreds if not thousands of times a day; day after day. Thus, over time, even a sensor having a small surface area will be impacted by a significant amount of spatter and/or weld flash. Of equal importance is the fact that due to the configuration and arrangement of the welding units at any given welding station, it is not uncommon for weld zones of the weld units to overlap. Thus, a sensor could be subjected to hot projectiles from a plurality of different sources.

Excessive heat, spatter, and weld flash are particularly troublesome because the destructive effect they have on the sensing surfaces of the sensors. When extraneous weld byproducts such as spatter or weld flash material impact a typical sensing surface comprised of glass reinforced thermoplastic or thermoset plastic they may bounce off harmlessly, but more often than not they form pits or become embedded in the material. As one may appreciate, pitting and embedding form surface irregularities that increase the surface area of the sensing surface upon which successive bits of extraneous weld material may more easily adhere. Over time, additional spatter or weld flash will often form an accumulation or accretion on the sensing surface. And, because this accretion is primarily metallic, it affects the operation of the sensor (which is usually designed to sense metallic objects). That is, the spatter or flash may accumulate to the extent where it becomes detectable and it combines with the material to be welded to trigger the sensor prematurely. Or, the flash may accumulate to the extent where it effectively operates as the material to be welded and the sensor is continuously triggered.

Therefore, sensors must be continually inspected and tested for the effects of welding byproducts or, alternatively, be periodically replaced according to a predetermined schedule. In either case, the fact remains that sensors used in the above-mentioned working conditions will ultimately require replacement—in as little as 500 weld cycles per welding unit. As will be understood, each time a sensor has to be replaced, the assembly line must be shut down. One can appreciate the magnitude of the problem this creates when one considers a situation where there is a plurality of assembly lines, with each assembly line having a plurality of welding stations, with each welding station having a plurality of sensors, and with each sensor subject to the effects of high temperatures and welding byproducts. As one may imagine, replacing such sensors can result in significant down time.

Initially, thermoplastic materials such as glass filled polyamide nylon 6 (PA6) and glass filled polyamide nylon 12 (PA12) were used for sensing surfaces of sensors. With this type of material, small bits of slow moving welding byproducts having low levels of kinetic energy were able to bounce off, due to the material's somewhat resilient nature. However, because of the thermoplastic's relatively low glass transition and melting points, they were susceptible to impacts by the larger bits of welding byproducts having higher levels of kinetic energy, which formed pits primarily by melting the material. In an effort to reduce pitting, thermoset materials were tried. Because thermoset plastic materials have relatively higher glass transition and melting points, they were better able to resist pitting caused by high temperatures and hot welding byproducts. However, they were comparatively more brittle than the thermoplastics and were susceptible to pitting due to impacts of welding byproducts that knocked off fragments of the material. Thus, accretions of welding byproducts were able to form on both types of materials.

In an effort to minimize and/or reduce the effect of welding byproducts such as spatter and weld flash on non-metallic sensing surfaces, other materials such as Kevlar® and ceramics have been tried. However, these materials suffer from the same drawbacks as the above-mentioned thermoplastics and thermoset plastics. That is, they are either too soft or too hard and do not solve the problems associated with weld flash, namely the accretion of weld material on the sensing surface of the sensor.

There is a need to provide the sensing surface of a sensor so that it is able to withstand high temperatures, welding byproducts, spatter, weld flash, abrasion, impacts and harsh environments.

### BRIEF SUMMARY OF THE INVENTION

The present invention comprises a protective cover for the sensing surface of a control sensor. The cover comprises a layer of material having one or more of the following characteristics: a preferred shore-A durometer hardness in the range of 60-90, a preferred tensile strength of 1320 psi (92.82 kilogram-force per square centimeter (kgf/cm2)) or greater, a preferred dielectric strength of around 300 volts/mil, and a preferred thermal conductivity of 0.3 to 0.5×10⁻³ cal/sec², and a temperature stability of about −55 to +200 degrees Celsius. In use, the cover is positioned so that it effectively protects the sensing surface of the control sensor. Preferably, the cover is positioned between sensing surface of a control sensor and the source of the high temperature and welding byproducts. While this may be at a location spaced from the sensing surface, it is preferred that the cover be positioned adjacent to or in substantial contact with the sensing surface. Optionally, the cover may be secured to the control sensor with a suitable adhesive. The cover may be used in situations where the sensing surface of a control sensor is recessed, relative to a weld facing surface of a support to which it is attached. And, the cover may also be used in situations where the sensing surface is substantially flush with a weld facing surface of a support to which it is attached. In yet other situations, the cover may be used in situations where the sensing surface of a control sensor projects from a weld facing surface of the support to which it is attached.

An object of the present invention is to protect the sensing surface of a control sensor so that it is able to resist harsh work environments.

It is another object of the present invention to increase the operational life of a control sensor.

A feature of the present invention is that it can be easily cleaned and/or replaced.

An advantage of the present the invention is that the protective material may take the form of a laminate that can be operatively attached to a wide variety of control sensors.

Additional objects, advantages and features of the invention will be set forth in part in the description which follows, and in part will become apparent to those skilled in the art upon examination of the following or may be learned by practice of the invention. The objects and advantages of the invention may be realized and attained by means of the instrumentalities and combination particularly pointed out in the appended claims.

### BRIEF DESCRIPTION OF THE DRAWINGS

FIG. 1 is a perspective view of a first embodiment of a protective cover of the present invention;

FIG. 2 is a cross-sectional, side elevational view of the protective cover of FIG. 1;

FIG. 3 is a perspective view of a second embodiment of a protective cover of the present invention;

FIG. 4 is a cross-sectional, side elevational view of the protective cover of FIG. 3;

FIG. 5 is a perspective view of a control sensor;

FIG. 6 is a side elevational view of the control sensor of FIG. 5;

FIG. 7 is a partial cross-sectional, side elevational view of the protective cover of FIGS. 1 and 2 as it may be used with the control sensor of FIGS. 5 and 6;

FIG. 8 is a partial cross-sectional, side elevational view of the protective cover of FIGS. 3 and 4 as it may be used with the control sensor of FIGS. 5 and 6;

FIG. 9 is a partial cross-sectional, side elevational view of the protective cover of FIGS. 1 and 2 as it may be used with the control sensor of FIGS. 5 and 6; and,

FIG. 10 is a partial cross-sectional, side elevation view of the protective cover of FIGS. 3 and 4 as it may be used with the control sensor of FIGS. 5 and 6 and as it may be positioned relative to a welding unit.

### DESCRIPTION OF THE PREFERRED EMBODIMENTS

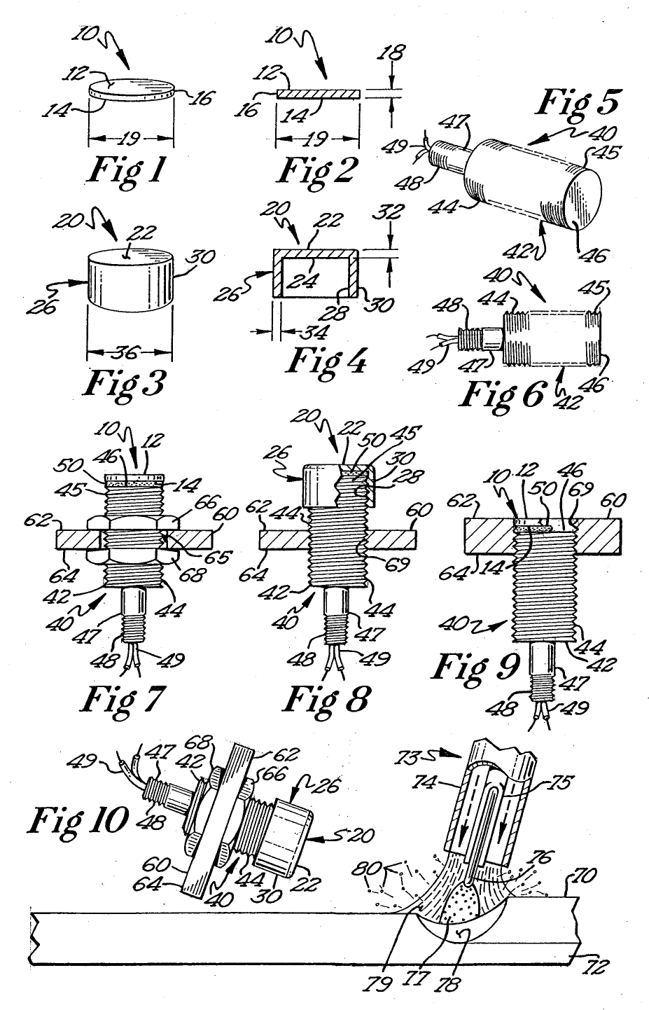

Referring to FIGS. 1 and 2, a preferred embodiment of the protective cover is depicted. The cover 10 includes a first surface 12 a second surface 14 and an edge 16. The cover 10 comprises a layer of material having one or more of the following characteristics: a preferred shore-A durometer hardness in the range of 60-90, a preferred tensile strength of 1320 psi (92.82 kilogram-force per square centimeter (kgf/cm2)) or greater, a preferred dielectric strength of around 300 volts/mil, and a preferred thermal conductivity of 0.3 to 0.5×10⁻³ cal/sec², and a temperature stability of about −55 to +200 degrees Celsius. Preferably, the material comprises silicone. More preferably, the material comprises gray-colored silicone that can be molded under thermosetting conditions and later cut to shape. The thickness 18 of the cover, which is defined by the opposing surfaces 12 and 14, is configured so that it does not interfere with the operation of the sensor and yet offers protection from high temperatures, splatter, and weld flash. Preferably, the thickness 18 is greater than 0.00075 inches (0.01905 mm). More preferably, the thickness 18 that is greater than 0.0010 inches (0.0254 mm). It will be understood, that as the thickness 18 increases, the ability of the sensor to operate as intended will decrease. This can be attributed to the composition of the material as well as the physical increase in distance between the sensing surface and an object to be detected. It will be appreciated, then, that there will a point where the protection provided by a thicker cover will prevent normal operation of the sensor. It has been discovered that there is an optimal upper limit of thickness that allows the cover to effectively protect the sensing surface, and which allows the control sensor to operate within normal operational parameters. The upper limit is around 0.0030 inches (0.0762 mm) and preferably around 0.0020 inches (0.05080 mm). It should be understood that while the preferred embodiment of the cover is depicted as being substantially circular (having a preferred diameter 19 in the range of around 8 to 18 mm) other configurations are possible, depending upon the configuration of the sensor with which it is being used.

Referring now to FIGS. 3 and 4, another preferred embodiment of the protective cover is depicted. The cover 20 includes a first surface 22 a second surface 24 and a side wall or skirt 26 having an inner surface 28 and an outer surface 30 that define the thickness 34 of the side wall, which has a preferred thickness in the range of about 0.00075 inches (0.01905 mm) to 0.0030 inches (0.0762 mm). As with the previously described embodiment, the cover 20 comprises a layer of material having one or more of the following characteristics: a preferred shore-A durometer hardness in the range of 60-90, a preferred tensile strength of 1320 psi (92.82 kilogram-force per square centimeter (kgf/cm2)) or greater, a preferred dielectric strength of around 300 volts/mil, and a preferred thermal conductivity of 0.3 to 0.5×10⁻³ cal/sec², and a temperature stability of about −55 to +200 degrees Celsius. Preferably, the material comprises silicone. More preferably, the material comprises gray-colored silicone that can be molded under thermosetting conditions and later cut to shape. The thickness 32 of the cover 20, which is defined by the opposing surfaces 22 and 24, is configured so that it does not interfere with the operation of the sensor and yet offers protection from high temperatures, splatter, and weld flash. Preferably, the thickness 32 is greater than 0.00075 inches (0.01905 mm). More preferably, the thickness 32 that is greater than 0.0010 inches (0.0254 mm). It should be understood that while the preferred embodiment of the cover is depicted as being substantially cylindrical (having a preferred diameter 36 in the range of around 8 to 20 mm), other configurations are possible, depending upon the configuration of the sensor with which it is being used.

FIGS. 5 and 6 depict a typical control sensor 40 (for example, model number Bi8U-MT18, manufactured by TURCK Inc., of Plymouth, Minn.). More specifically, the control sensor 40 is a proximity detector and includes a body 42 having an external thread 44 that is used to attach the sensor to a suitable support. The sensor 40 includes a first end 45 having sensing surface 46 and a second end 47 having an external thread 48 and an electrical interface that is connected to wiring 49.

FIG. 7 depicts the protective cover of FIGS. 1 and 2 as it may be used with the control sensor of FIGS. 5 and 6. As will be understood, in some situations the protective cover 10 may be positioned in contact with the sensing surface 46 of the control sensor and the molecular adhesion between the two will be sufficient to keep the cover in place. However, in other situations, it may be necessary and/or desirable to provide a more secure attachment. Therefore, a layer of adhesive material 50 may be positioned between the protective cover 10 and the sensing surface 46 of the control sensor 40. Generally, heat-resistant adhesive material is preferred. More preferably, epoxies, cyanoacrylates and their equivalents are used. It will be appreciated, that if the layer of adhesive material is too thick, the sensing capability of the control sensor may be adversely affected. And that the total thickness of the protective cover and the adhesive layer of material should be taken into account. It should be apparent that the adhesive material 50 as depicted FIG. 7 is not to scale. Rather the adhesive material, as depicted, is exaggerated to facilitate a clearer understanding of the invention. Alternatively, it is envisioned that a control sensor may be provided with a protective cover by applying the protective material directly onto the sensing surface in an uncured state and then curing the protective material in situ. For example, by dipping or spraying.

Continuing on, the cover 10 may be applied before or after the control sensor 40 (or proximity detector) is attached to a support 60. In a typical installation, the protective cover and control sensor are attached to a support 60 that includes a weld facing first surface 62, an opposing second surface 64 and an aperture 65. The aperture 65 receives the control sensor 40 so that the sensing surface 46 extends beyond the first surface 62 and the electrical interface 48 extends beyond the second surface 64. The control sensor 40 is secured to the support 60 by threaded nuts 66, 68, and lock washers (not shown).

FIG. 8 depicts the protective cover of FIGS. 3 and 4 as it may be used with the control sensor of FIGS. 5 and 6. It will be appreciated that in some situations the protective cover 20 may be positioned in contact with the sensing surface 46 of the control sensor and the frictional force exerted by the side wall or skirt 26 against the body 42 of the control sensor 40 may be sufficient to keep the cover in place. However, it may be necessary and/or desirable to provide a more secure attachment. Therefore, adhesive material 50 may be positioned between the protective cover 20 and the body of control sensor and/or between the cover 20 and the sensing surface 46 of the control sensor 40. Generally, heat-resistant adhesive material is preferred. More preferably, epoxies, cyanoacrylates and their equivalents are used. It will be appreciated, that if the layer of adhesive material is too thick, the sensing capability of the control sensor may be adversely affected. And that the total thickness of the protective cover and the adhesive layer of material should be taken into account. It should be apparent that the adhesive material 50 as depicted FIG. 8 is not to scale. Rather the adhesive material, as depicted, is exaggerated to facilitate a clearer understanding of the invention. It is envisioned that in certain circumstances, it may be necessary and or desirable to provide a control sensor with both embodiments of the protective covers. That is, a protective cover 10 may be retained in position by a protective cover 20.

As shown in the installation of FIG. 8, the protective cover and control sensor are attached to a support 60 that includes a weld facing first surface 62, an opposing second surface 64 and a threaded aperture 69. The threaded aperture 69 engages the thread 44 of the control sensor 40 and may be adjusted so that the sensing surface 46 extends beyond the first surface 62 and the electrical interface 48 extends beyond the second surface 64. The control sensor 40 may be secured to the support 60 by one or more threaded nuts and lock washers (not shown).

FIG. 9 depicts the protective cover of FIGS. 1 and 2 as it may be used with the control sensor of FIGS. 5 and 6. It will be appreciated that in some situations the protective cover 10 may be positioned in contact with the sensing surface 46 of the control sensor and the frictional force exerted by the side wall 16 against the threaded aperture 69 of the support 60 may be sufficient to keep the cover in place. However, in other situations, it may be necessary and/or desirable to provide a more secure attachment. Therefore, adhesive material 50 may be positioned between the protective cover 1 0 and the sensing surface 46 of the control sensor 40. Generally, heat-resistant adhesive material is preferred. More preferably, epoxies, cyanoacrylates and their equivalents are used. It will be appreciated, that if the layer of adhesive material is too thick, the sensing capability of the control sensor may be adversely affected. And that the total thickness of the protective cover and the adhesive layer of material should be taken into account. It should be apparent that the adhesive material 50 as depicted FIG. 9 is not to scale. Rather the adhesive material, as depicted, is exaggerated to facilitate a clearer understanding of the invention.

As shown the installation of FIG. 9, the protective cover and control sensor are attached to a support 60 that includes a weld facing first surface 62, an opposing second surface 64 and a threaded aperture 69. The threaded aperture 69 engages the thread 44 of the control sensor 40. Here, the control sensor 40 is positioned so that the sensing surface 46 is recessed with respect to the first surface 62 and the electrical interface 48 extends beyond the second surface 64. Note that the control sensor 40 may be secured to the support 60 by a threaded nut and lock a washer (not shown).

Referring now to FIG. 10, a partial, sectional view of a control sensor 40 and protective cover 20 are shown as they may be used in conjunction with a GMAW welding unit 73. In this preferred embodiment, the control sensor 40 is an inductive proximity detector and it is oriented so that its sensing surface faces the welding zone. From this position, the control sensor 40 is able to detect when the work pieces 70, 72 are in the correct position for welding. Although the preferred embodiment of the control sensor 40 is an inductive proximity detector, it should be apparent that other detectors and sensors that utilize electromagnetic waves may be used, for example, infrared, magnetic, VHF, UHF, radio, etc.

Note, in this figure, that the control sensor 40 is positioned so that the sensing surface (hidden by protective cover 20) is in the weld zone where most of the high temperatures, spatter, and weld flash are produced. It is understood, however, that the control sensor and sensing surface need not directly face the welding unit. For instance, the sensing surface may be perpendicular or parallel with respect to the work pieces 70, 72 (not shown). Or, the sensing surface may be positioned to the right of the welding unit (not shown).

The partial welding unit 73 depicted in FIG. 10 is a gas-metal arc welding unit (GMAW) of the type having opposing a gas nozzle 74 and a contact tube 75 that houses a combustible electrode 76. In operation, a high electrical current produces an arc 77 between the consumable electrode 76 and the weld material. This forms a weld pool 78 that, when sufficiently cooled, joins the work pieces 70, 72 together. Oxidation is prevented by a flow of inert gas 79, which envelopes the arc 77 and weld pool 78. As mentioned above, during the welding process, high temperatures, and welding byproducts such as spatter and weld flash 80, are ejected from the weld site. As depicted, the weld zone for the GMAW welding unit is primarily to the right of the weld site. It will be appreciated, however, that different welding set-ups will have different weld flash zones.

The present invention having thus been described, other modifications, alterations or substitutions may present themselves to those skilled in the art, all of which are within the spirit and scope of the present invention. It is therefore intended that the present invention be limited in scope only by the claims attached below:

What is claimed is:

1. A cover suitable for use in protecting a portion of a control sensor that is subject to welding byproducts, wherein the cover is configured and arranged to effectively protect said portion of the proximity detector.

2. The cover of claim 1, wherein the cover is a layer of silicone that has a thickness that is greater than 0.00075 inches (0.01905 mm).

3. The cover of claim 1, wherein the cover is a layer of silicone that has a thickness in the range of around 0.0010 to 0.0020 inches (0.0254 to 0.05080 mm).

4. The cover of claim 1, wherein the cover is a layer of silicone that has a hardness in the range of about 60 to 90 durometer (Shore A).

5. The cover of claim 1, wherein the cover is a layer of silicone that has a hardness in the range of about 65 to 85 durometer (Shore A).

6. The cover of claim 1, wherein the cover is a layer of silicone that has a hardness in the range of about 70 to 80 durometer (Shore A).

7. The cover of claim 1, wherein the cover is a layer of material that has a minimum tensile strength of around 1320 psi. (92.827 kg/cm.).

8. The cover of claim 1, wherein the cover is comprised of substantially silicone material.

9. The combination of a proximity detector of the type having body and a sensing surface, and a cover of protective material, wherein the material is configured and arranged to effectively protect the sensing surface of the proximity detector.

10. The combination of claim 9, wherein the cover comprises substantially silicone material.

11. The combination of claim 9, wherein the cover has a hardness in the range of about 60-90 durometer (Shore A).

12. The combination of claim 9, wherein the cover comprises material that has a minimum tensile strength of around 1320 psi. (92.827 kg/cm.).

13. The combination of claim 9, further comprising an effective amount of adhesive material interposed between the cover and the proximity detector.

14. The combination of claim 13, wherein the adhesive is an epoxy-based adhesive.

15. The combination of claim 13, wherein the adhesive is a cyanoacrylate-based adhesive.

16. The combination of claim 13, wherein the adhesive is located between the cover and the sensing surface of the proximity detector.

17. The combination of claim 9, wherein the cover comprises a substantially planar sheet having two opposing surfaces.

18. The combination of claim 9, wherein the cover comprises a first surface, a second surface and a side wall, with the side wall connected to and extending from one of the first or the second surfaces, and wherein the side wall is configured and arranged to contact the body of the proximity detector.

19. The combination of claim 18, further comprising an effective amount of adhesive interposed between the cover and the proximity detector.

20. The combination of claim 13, wherein the cover and the adhesive have a thickness greater than 0.00075 inches (0.01905 mm).
